(19) United States
(12) Patent Application Publication
(10) Pub. No.: US 2008/0310337 A1
(43) Pub. Date: Dec. 18, 2008

(54) Periodic heartbeat communication between devices and a control point

(75) Inventor: Devon Welles, Hillsboro, CA (US)

Correspondence Address: MURABITO, HAO & BARNES, LLP, TWO NORTH MARKET STREET, THIRD FLOOR, SAN JOSE, CA, 95113, US

(73) Assignee: Gainspan, Inc.

(21) Appl. No.: 11/820,236

(22) Filed: Jun. 18, 2007

(51) Int. Cl. G08C 17/00

(52) U.S. Cl. 370/311

(57) ABSTRACT

A method, apparatus and system of periodic heartbeat communication between devices and a control point is disclosed. In one embodiment, a method includes generating a periodic heartbeat signal using a counter of a system on chip embedded in a device, and communicating the heartbeat signal to a control point managing the device to trigger a communication between the device and the control point in order to allow the device to use a low power mode between heartbeat communications. In another embodiment, a method includes communicating a heartbeat signal of a device to a control point when the device is coupled to a network of the device and the control point managing the device, performing a key exchange between the device and the control point to authenticate the device, and configuring the device based on parameter data of the control point when key exchange is successful.

### FIELD OF TECHNOLOGY

This disclosure relates generally to technical fields of software and/or hardware and, in one embodiment, to a method, system and apparatus of a periodic heartbeat communication between devices and a control point.

### BACKGROUND

Wireless devices may limit their communication with a base station so that they only communicate when absolutely necessary in order to conserve battery power. Although the base station may be keeping track of what devices it talks to, there may be no way to distinguish inactivity from a device leaving the network when no communication takes place between the base station and the device for a prolonged period of time. So, components that break, get thrown away, and/or simply get removed may still appear on the network since they were once members (e.g., and/or the base station does not keep track of the current state of the device). Also, the intermittent nature of the wireless devices' communication with the base station may make it difficult for the base station to communicate with the wireless devices, whether to send them a configuration message and/or update their firmware.

### SUMMARY

A method, apparatus and system of periodic heartbeat communication between devices and a control point are disclosed. In one aspect, a method includes generating a periodic heartbeat signal (e.g., or an aperiodic heartbeat signal) using a counter of a system on chip embedded in a device (e.g., a wired device and/or a wireless device), and communicating the heartbeat signal to a control point managing the device to trigger a communication between the device and the control point.

The method may include waking up the system on chip to generate the heartbeat signal when the counter of the system on chip reaches a preset value. The method may also include communicating signal data (e.g., which may include a battery condition) of the device to the control point. In addition, the method may include configuring the device through processing configuration data of the control point. The method may further include performing a firmware update of the device through processing firmware update data of the control point.

Moreover, the method may include initiating one or more operations of the device based on one or more command data of the control point. Furthermore, the method may include varying a period of the periodic heartbeat signal based on a type of the device. Additionally, the method may include performing a two way communication (e.g., which may last about 200 milliseconds) between the device and the control point subsequent to the waking up the system on chip. Alternatively, the method may include reverting the device to a sleep mode upon performing the communicating the heartbeat signal to the control point (e.g., which may last about 10 microseconds).

In another aspect, a method includes communicating a heartbeat signal (e.g., which may inform the control point of a wake-up mode of the device such that the control point is able to communicate with the device) of a device to a control point when the device is coupled to a network of the device and the control point managing the device, performing a key exchange (e.g., which may also be performed periodically to check a tampering of the device such that the device is removed from the network when the tampering of the device is detected) between the device and the control point to authenticate the device, and configuring the device based on parameter data of the control point when the key exchange is successful. The method may also include providing a tiered access to a user of the network based on login data of the user.

In yet another aspect, a system on chip includes a real time counter module to count clock pluses of the system on chip embedded in a device, and a heartbeat module coupled to the real time counter module to generate a heartbeat signal (e.g., which may be periodically communicated to the control point such that a presence of the device is confirmed by the control point based on the heartbeat signal) when a number of the clock pluses is equivalent to a preset value to trigger a communication between the device and a control point managing the device.

Signal data of the control point may be communicated subsequent to the heartbeat signal to control the device. In addition, the system on chip may be placed back to a sleep mode when the heartbeat signal is communicated to the control point to minimize a power consumption of the system on chip.

The methods, systems, and apparatuses disclosed herein may be implemented in any means for achieving various aspects, and may be executed in a form of a machine-readable medium embodying a set of instruction that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a network view of a low power system on chip interacting with a controller and/or a number of external devices, according to one embodiment.

FIG. 2 is a schematic diagram of a low power wireless system on chip (SOC) having a real time counter module islanded from the rest of the low power system on chip, according to one embodiment.

FIG. 3 is an interaction diagram of software modules of the low power wireless SOC of FIG. 2, according to one embodiment.

FIG. 4 is a state diagram of the low power wireless SOC of FIG. 2, according to one embodiment.

FIG. 5 is a system diagram of a control point managing wireless devices associated with a central base station in a wireless network, according to one embodiment.

FIG. 6 is a process flow diagram of an algorithm implemented in the control point of FIG. 5, according to one embodiment.

FIG. 7 is the low power wireless SOC of FIG. 2 interacting with a host server through an access point, according to one embodiment.

FIG. 8 is a diagrammatic system view of a data processing system in which any of the embodiments disclosed herein may be performed, according to one embodiment.

Other features of the present embodiments will be apparent from the accompanying drawings and from the detailed description that follows.

### DETAILED DESCRIPTION

A method, apparatus and system of periodic heartbeat communication between devices and a control point are disclosed. In the following description, for purposes of explanation, numerous specific details are set forth in order to provide a thorough understanding of the various embodiments. It will be evident, however, to one skilled in the art that the various embodiments may be practiced without these specific details.

In one embodiment, a method includes generating a periodic heartbeat signal using a counter of a system on chip embedded in a device, and communicating the heartbeat signal to a control point managing the device to trigger a communication between the device and the control point.

In another embodiment, a method includes communicating a heartbeat signal of a device to a control point when the device is coupled to a network of the device and the control point managing the device, performing a key exchange between the device and the control point to authenticate the device, and configuring the device based on parameter data of the control point when the key exchange is successful.

In yet another embodiment, a system on chip includes a real time counter module to count clock pluses of the system on chip embedded in a device and a heartbeat module coupled to the real time counter module to generate a heartbeat signal when a number of the clock pluses is equivalent to a preset value to trigger a communication between the device and a control point managing the device.

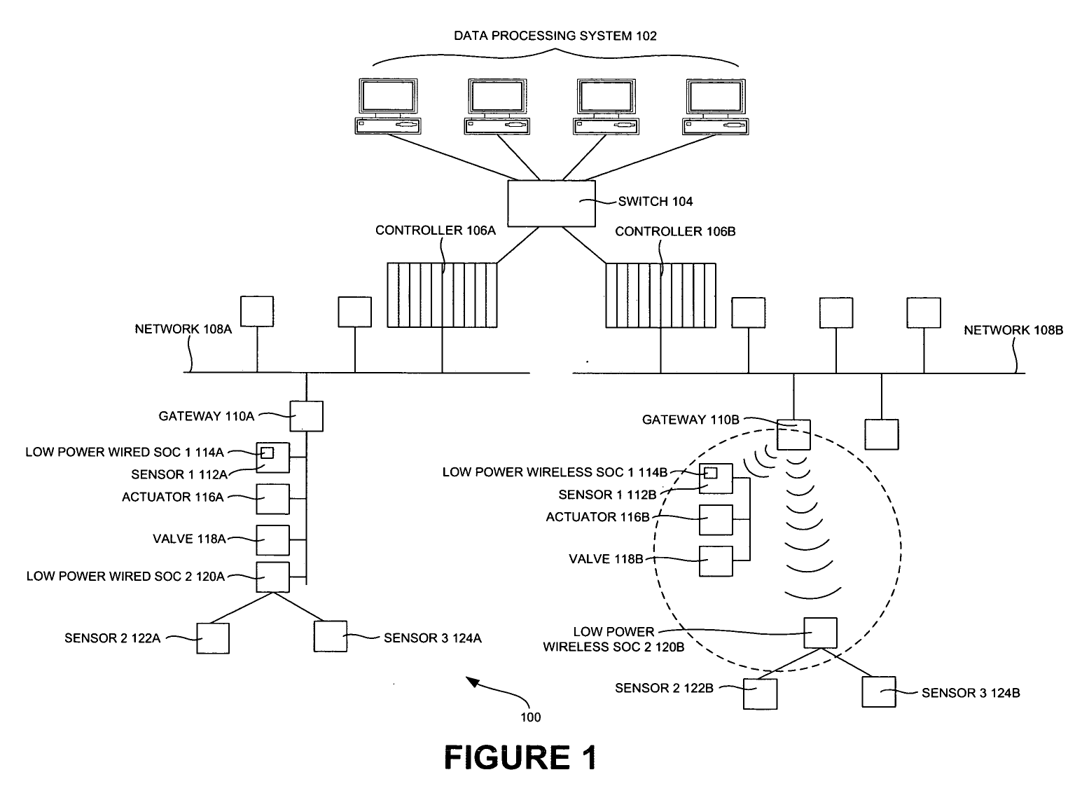

FIG. 1 is a network view of a low power system on chip 114 interacting with a controller 106 and/or a number of external devices, according to one embodiment. The low power system on chip (SOC) 1 114 (e.g., the low power wired SOC 1 114A and/or a low power wireless SOC 1 114B) embedded in a sensor 112 may connect the number of external devices (e.g., the sensor 1 112, an actuator 116, a valve 118, etc.) to a gateway 110 (e.g., an access point). The gateway 110 may be connected to a network 108 (e.g., a WAN, a LAN, a WLAN, an internet, etc.) which may in turn be connected to other gateways communicating with other devices.

A low power SOC 120 (e.g., a low power wired SOC 2 120A and/or a low power wireless SOC 2 120B) may also externally control a sensor (e.g., a sensor 2 122 and/or a sensor 3 124). The network 108 (e.g., the network 108A and/or the network 108B) may be connected to the controller 106 (e.g., the controller 106A and/or the controller 106B) which is used to control a transmission of data over the network 108, the devices, and/or a switch 104 (e.g., which may be used to regulate the transmission of data between a data processing system 102 and/or the controller 106).

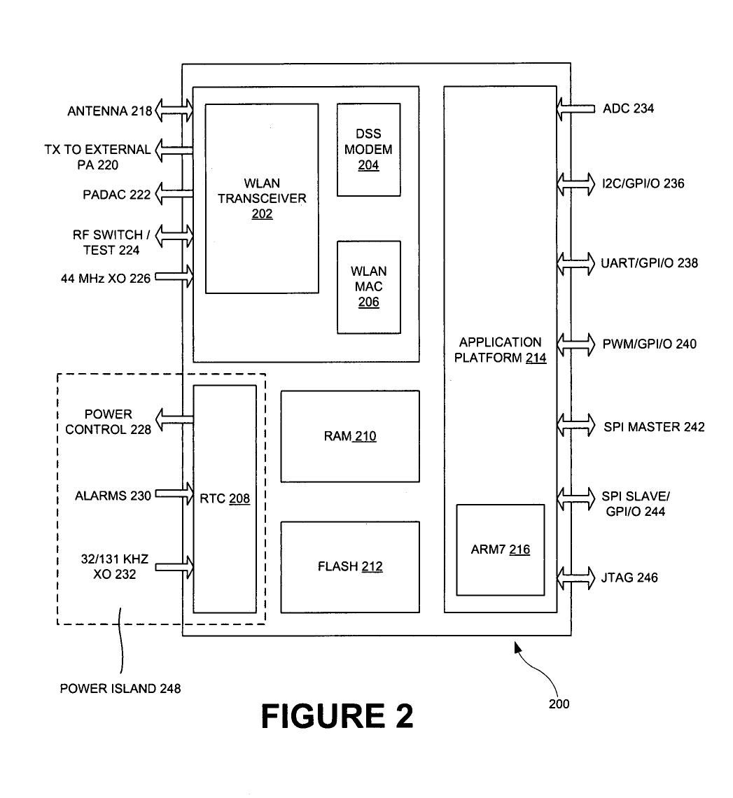

FIG. 2 is a schematic diagram of a low power wireless system on chip (SOC) 200 having a real time counter module 208 islanded from the rest of the low power system on chip, according to one embodiment. The low power wireless SOC 200 includes a dual-processor system (e.g., ARM7 216 based) with a direct-sequence spread spectrum (DSSS) Modem 204 (e.g., an IEEE 802.11b) and a WLAN transceiver 202 in a single chip. The low power wireless SOC 200 may be used by a wireless facility to monitor environmental conditions (e.g., a temperature, an occupancy, a humidity, a radiation, a vibration, a pressure, etc.).

In one example embodiment, the low power wireless SOC 200 may have a 2.4 GHz complementary metal-oxide-semiconductor (CMOS) WLAN transceiver 202, which may have an embedded power amplifier (PA) with a programmable output power (e.g., up to 12 dBm). The PA output may be merged with low-noise amplifier (LNA) inputs. The direct-sequence spread spectrum (DSSS) modem 204 may modulate for data rates (e.g., 1 Mb/s and/or 2 Mb/s). A transmitted signal of the DSSS modem 204 may take up more bandwidth than an information signal that is being modulated (e.g., where the name ‘spread-spectrum’ comes from the fact that the carrier signals occur over the full bandwidth (spectrum) of the device's transmitting frequency).

The DSSS modem 204 may multiply the data being transmitted by a noise signal, which is a pseudorandom sequence of 1 and −1 values, at a frequency much higher than that of original signal, thereby spreading energy of the original signal into a much wider band. The resulting signal may resemble a white noise, except that the resulting signal may be filtered out at a receiving end to recover the original signal by multiplying the same pseudorandom sequence to the received signal (because 1×1=1, and −1×−1=1).

As shown in FIG. 2, the low power wireless SOC 200 may have a WLAN medium access control (MAC) 206, which provides addressing and channel access control mechanisms that makes it possible for several terminals and/or network nodes to communicate with the WLAN transceiver 202. The MAC data communication protocol sub-layer may be a part of a seven-layer OSI model data link layer (layer 2). The MAC sub-layer may act as an interface between the Logical Link Control sub-layer and the network's physical layer. The MAC layer may provide an addressing mechanism called physical address or MAC address (e.g., a unique serial number which may be assigned to each network adapter, making it possible to deliver data packets to a destination within a sub-network, which may be a physical network without routers (e.g., an Ethernet LAN, a WLAN, etc.). The low power system on low power wireless SOC 200 may include high-throughput hardware with two small private random access memories (RAM) for encryption/decryption, hardware co-processing for demanding lower-MAC tasks and hardware support of IEEE 802.11i, (e.g., Counter Mode with Cipher Block Chaining Message Authentication Code Protocol (CCMP), which is a full security IEEE 802.11i encryption protocol).

The application platform (APP) 214 may be a dual processor platform which may include two ARM7 216, one to run the WLAN software and the other to run the application software, running at specified frequency (e.g., 11, 22, 44 MHz). The ARM architecture may be a 32-bit reduced instruction set computer (RISC) architecture that may widely be used in a number of embedded designs. Due to their power saving features, ARM central processing units (CPU) are dominant in the mobile electronics market, where low power consumption is a critical design goal. The APP may be based on two separated AMBA high performance busses (AHB) to maximize the bandwidth allowed to each CPU (e.g., to avoid time-sharing when using the bus so that both CPUs are fully operational at all times). The CPUs may also be equipped with Joint Test Action Group (JTAG) test access ports 246 for hardware debug purposes.

The low power wireless SOC 200 may include a random access memory (RAM) 210 including a shared memory of 192 K bytes for both CPUs and dedicated RAM of 32K bytes for the WLAN CPU. The shared RAM may be mainly used by the APP CPU and may contain the data frames for inter-CPU communication. However, the shared RAM may also be used by the WLAN CPU during software update procedures and for future extensions of the WLAN stack if feasible. As illustrated in FIG. 2 the low power wireless SOC 200 also may have 384 K bytes of embedded Flash memory 212 which may be used to update firmware. On-chip start-up code may be located in a dedicated boot ROM which may be divided for the use of each CPU.

FIG. 2 also illustrates a Real Time Clock (RTC) 208 which may provide global time and/or date to the low power wireless SOC 200. The RTC 208 may contain a low-power crystal oscillator that supports a 32.768 kHz crystal and/or a 131.072 kHz crystal 232. The RTC 208 may run on a dedicated power supply, ranging between 1.2V and 3.6V. Three programmable wrap-around alarm counters may be provided to enable periodic wake-up of the low power wireless SOC 200 and two independent external components. Two alarm inputs 230 (e.g., external) may enable wake-up of the low power wireless SOC 200 on external events.

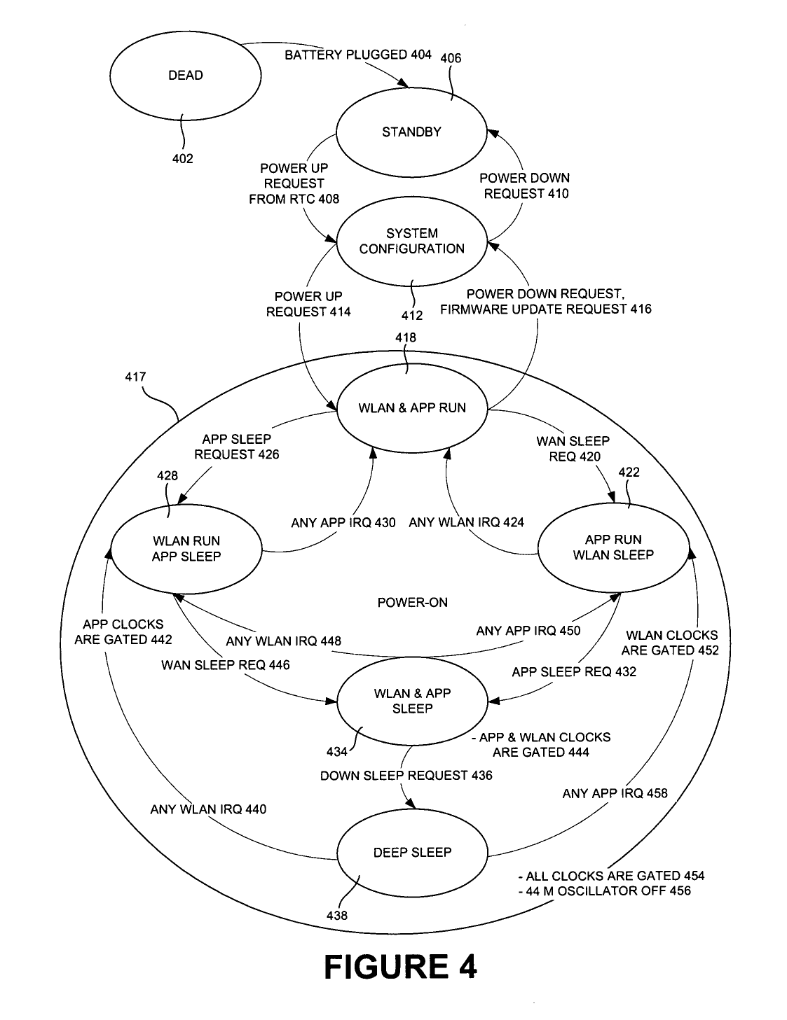

Interfaces may include support of an external serial E²PROM parameter memory and/or a serial flash data memory through a serial peripheral interface (SPI), two multi-purpose universal asynchronous receiver/transmitter (UART) interfaces 238, external CPU interfaces via SPI master 242 and SPI slave/GPI/O 244 interface, up to 32 General Purpose I/Os, three pulse-width modulated (PWM) function outputs 240, and I²C master and slave interface 236. The interfaces may also include support for two 10 bits 32K samples/ADC channels 234, two alarm inputs 230, three control outputs for power supply 228, external radio frequency (RF) switches/test 224, and support for external power amplifier, such as, dedicated transmitter (Tx) output 220 and/or PA digital-to-analog converter (DAC) output 222. The low power wireless SOC 200 may be connected to an antenna 218 to receive and/or transmit data to and/or from an access point. Along with low-power modes to be described in FIG. 4, the low power wireless SOC 200 may also have power supply monitoring and/or temperature monitoring capabilities. These features may help the device be alert for over and under voltage fault conditions.

Furthermore, a hardware module of the low power wireless SOC 200 (e.g. which includes one or more of a microcontroller, a microprocessor, a DSP core, a memory, a timing source, a peripheral, an external interface, etc.) may have the real time counter (RTC) 208 of the peripheral isolated from a rest of the hardware module using more than one voltage level shifting cells and/or more than one voltage island cells (e.g., which is placed between the RTC 208 and the rest of the hardware module such that two different voltages are separately applied to the RTC 208 and the rest of the hardware module). Also, a software module (e.g., of the application platform 214) associated with the RTC 208 may generate one or more control signals to one or more devices external to the low power wireless SOC 200 during a sleep mode (e.g., the sleep mode places any unused part of the low power wireless SOC 200 in a non-operational mode to reduce power consumption) of the low power wireless SOC 200 to communicate with the one or more devices.

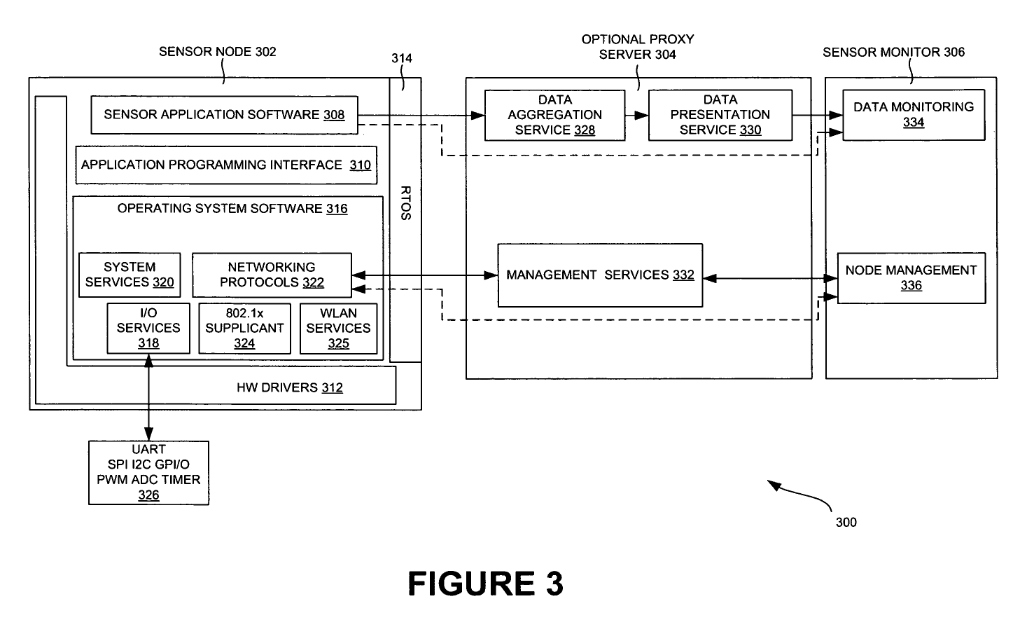

FIG. 3 is an interaction diagram of software modules of the low power wireless SOC of FIG. 2, according to one embodiment. A sensor node 302 may denote the location of a particular sensor (e.g., and/or other external devices) connected to the low power wireless SOC 200. The sensor node 302 may contain a sensor application software 308 which may be used to control the sensor (e.g., and/or other external devices) via a real-time operating system (RTOS) 314. The RTOS 314 may be a class of operating system intended for real-time applications. The RTOS 314 may operate on the hardware (HW) using hardware (HW) drivers 312. An operating system software 316, which may include system services 320, which may act as an intermediary between the RTOS 314 and the HW drivers 312, networking protocols 322, a 802.1x supplicant 324, WLAN services 325 and I/O services 318 via a UART, SPI, I2C, GPI/O, PWM, ADC, TIMER, etc. 326.

The sensor application software 308 may transmit the data to an optional proxy server 304 which may be used to manage communication of data and/or operation commands between the sensor node 302 and a sensor monitor 306. In one example embodiment, the data may be transmitted directly from the sensor application software 308 to the sensor monitor 306 (e.g., thus not requiring the service of the optional proxy server 304). In the optional proxy server 304, the data may be stacked in a data aggregation service 328 and/or may be organized and formatted in a data presentation service 330 so that it may be communicated to the sensor monitor 306. A management services module 332 in the optional proxy server 304 may be used to manage communication between the sensor node 302 and the sensor monitor 306. The data may finally be presented to the data monitoring module 334 (e.g., in the sensor monitor 306) which performs data processing/analysis based on an operator and/or a software within the data monitoring module 334 to issue commands to the sensor node 302.

FIG. 4 is a state diagram of the low power wireless SOC 200 of FIG. 2, according to one embodiment. A dead state 402 may imply that no power source is connected to the system. When a battery 404 is plugged in, the real time clock (RTC) 208 may be powered up and the low power wireless SOC 200 makes a transition from the dead state 402 to a stand-by state 406. The RTC 208 may be supplied directly from a battery (e.g., a battery plugged 404). Here, the low power wireless SOC 200 may show the lowest power consumption. The stand-by state 406 may be entered between active phases. When a power up request 408 is made by the RTC module, the low power wireless SOC 200 makes a transition from the stand-by state 406 to a system configuration state 412.

To switch on the low power wireless SOC 200, a DC/DC converter (e.g., regulating a voltage input to the low power wireless SOC 200) needs to be on, the power isolation from the RTC 208 needs to be removed, and/or a 44 MHz oscillator needs to be switched on. In this state, only a reset of the WLAN subsystem may get released by the RTC 208. The WLAN CPU may execute required system configurations before the low power wireless SOC 200 moves on to a general operation state, through another power-up request 414 to switch to a power-on state 417. The system configuration state 412 may also make a transition from the power-on state 417 to the system configuration state 412 using a power-down request and/or a firmware update request 416.

Another power-down request 410 may be made to make a transition from the system configuration state 412 to the stand-by state 406. The power-on state 417 may be an active state where the low power wireless SOC 200 is running. The power-on state 417 may have various sub-states, when unused parts of the system may be programmed to be in a non-operational mode reducing power consumption. These sub-states may be combined in a sleep state, which may be generically defined as a low-power condition. The several sub-states of sleep (e.g., the APP RUN WLAN SLEEP 422, the WLAN RUN APP SLEEP 428, THE WLAN & APP SLEEP 434, and THE DEEP SLEEP 438) may result in several scenarios as can be observed in FIG. 4.

The common characteristic of the sleep states may be that both the system voltage and the system clock are available, but the clock to specific parts of the system may be gated. For instance, one of the processors might be in a wireless fidelity (Wi-Fi) mode with its clock gated, while the other processor may be running. The system may be in the deep-sleep state 438 when all parts of the core system are in the sleep state and the 44 MHz oscillator may be switched off. Furthermore, the low power wireless SOC 200 of FIG. 2 draws about 3 micro amps during the deep-sleep state compared to 300 milli amps drawn by the low power wireless SOC 200 when the rest of the hardware module is operational

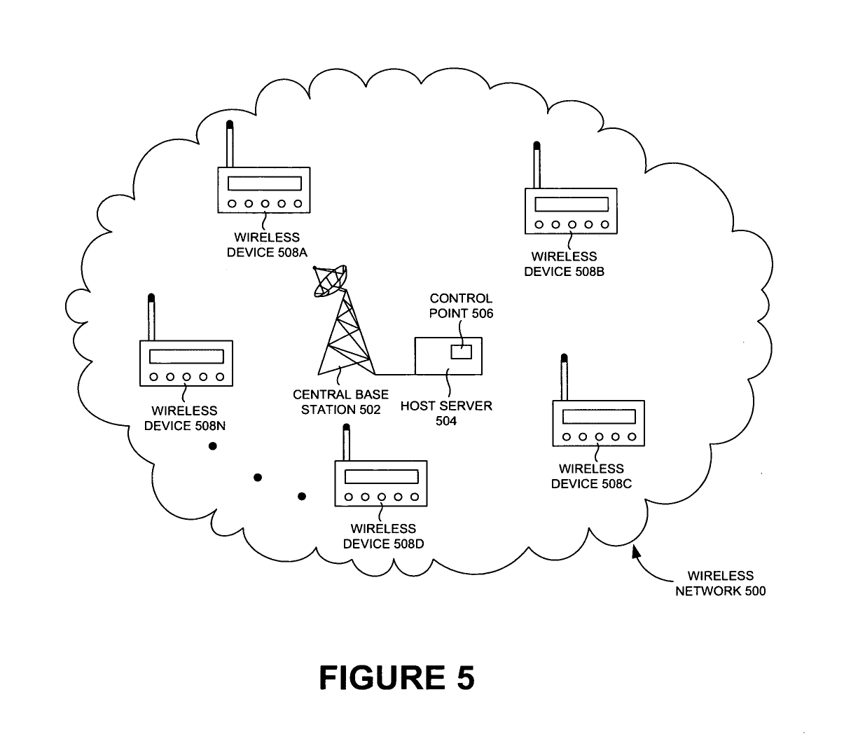

FIG. 5 is a system diagram of a control point 506 managing wireless devices 508 associated with a central base station 502 in a wireless network 500, according to one embodiment. Particularly, FIG. 5 illustrates the wireless network 500, the central base station 502, a host server 504, the control point 506, and/or the wireless devices 508.

The wireless network 500 may be a Wireless Local Area Network (WLAN), a Global System for Mobile Communications (GSM), a Personal Communication Service, a Digital Advanced Mobile Phone Service (D-AMPS), a Wi-Fi, and/or a Fixed Wireless Data Network.

The central base station 502 may be a radio receiver/transmitter that serves as a hub of the local wireless network, a gateway between a wired network and the wireless network 500 and/or a two-way radio installation in a fixed location that may be used to communicate with one or more of the wireless devices 508. The host server 504 may be a computer that enables communication between the host server 504 and the wireless devices 508 and/or among the wireless devices 508. The control point 506 may be a protocol, and/or an algorithm that may direct an operation of the host server 504. The wireless devices 508 (e.g., which may be sensors such as a temperature sensor, a humidity sensor, a motion sensor, etc.) may include a low-power two-way radio (e.g., which may be featured in the low power system on chip 114 of FIG. 1 embedded in the wireless devices 508).

In one example embodiment, the central base station 502, the host server 504, and/or the control point 506 may form a system that eases the management, configuration and/or deployment of the wireless devices 508. The system may enable communication between and/or with the wireless devices 508 which may be intermittently active. The wireless devices 508 may communicate periodically (e.g., and/or aperiodically) with the central base station 502. This periodic communication may be infrequent enough to minimize an impact on a battery life and/or power consumption of the wireless devices 508, but may also be frequent enough to allow the wireless devices 508 (e.g. thrown out, broken, and/or taken away) to be automatically removed from the wireless network 500 when the central base station 502 does not receive their periodic communication message from the wireless devices 508.

This periodic communication may also provide regular opportunities to send configuration messages and/or firmware updates to the wireless devices 508, and/or to enact actions on the wireless devices 508. Because the periodic communication may be a regular event, this may provide a means to ensure that any of the tasks may be accomplished within a specified time, which may not be available currently when a person relies on the wireless devices 508 to initiate communication.

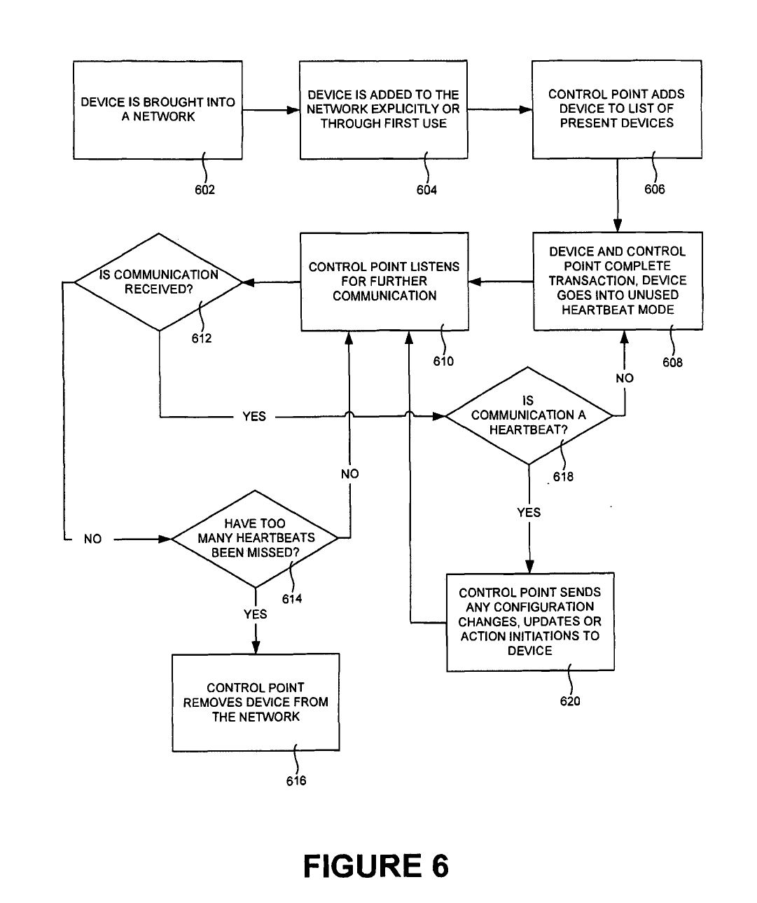

FIG. 6 is a process flow diagram of an algorithm implemented in the control point 506 of FIG. 5, according to one embodiment. In operation 602, the device 508 (e.g., wired and/or wireless) may be brought to the network (e.g., the wireless network 500 of FIG. 5). In operation 604, the device may be added to the network explicitly or through first use. In operation 606, the control point (e.g., the control point 506 of FIG. 5) of the network may add the device to list of present wireless devices. In operation 608, once the device and the control point complete the transaction (e.g., as stated in operation 604 and operation 606), the device may go into unused heartbeat mode.

In operation 610, the control point may be listening (e.g., through the central base station 502 of FIG. 5) for any incoming communications from the device (e.g., one or more of the wireless devices 508 of the wireless network 500 of FIG. 5). When there is no communication received (e.g., by the central base station 502 of FIG. 5) in operation 612 and/or too many heartbeats are missed (e.g., beyond a threshold value) in operation 614, the control point may remove the device from the network (e.g., and/or update the list of present devices through removing the device) in operation 616.

On the other hand, when there is communication between the device and the control point in operation 612, the communication is checked whether data received by the control point is a heartbeat signal in operation 618. If the data received by the control point is not the heartbeat signal, the control point listens for further communication as in operation 610. If the data received by the control point is indeed the heartbeat signal in operation 618, the control point may send configuration changes, updates, and/or action initiations to the devices (e.g., since the heartbeat signal indicates that the device is awake for a duration of time).

In one example embodiment, signal data (e.g., representing a battery condition and other data) of the device (e.g., the wireless device 508 of FIG. 5) may be communicated to the control point (e.g., the control point 506 of FIG. 5). Also, the device may be configured through processing configuration data of the control point. For example, one of the configuration data may be a mode of operation of the device. When the device (e.g., a thermostat) is beaconed with the configuration data (e.g., indicating the end of workday, thus setting a new mode for the device), the device may turn the light off and communicate the heartbeat signal every hour rather than every minute (e.g., because people have gone home by then).

Additionally, the firmware update of the device may be performed through processing firmware update data of the control point. Moreover, one or more operations of the device may be initiated based on one or more command data of the control point. Furthermore, a period of the periodic heartbeat signal may be varied based on a type of the device. For instance, in a critical situation such as updating the status of a toxic material, the heartbeat signal of the device (e.g., a sensor) may be generated in a short interval (e.g., very frequently). On the other hand, if the device monitoring the light level of a warehouse, the heartbeat signal may be generated in a long interval (e.g., less frequently).

In addition, a two way communication between the device and the control point (e.g., which may last about 200 milliseconds) may be performed subsequent to the waking up the system on chip. Alternatively, the device may be reverted to the sleep mode (e.g., the deep sleep mode 438 of FIG. 4) upon performing the communicating the heartbeat signal to the control point (e.g., which may last about 10 milliseconds).

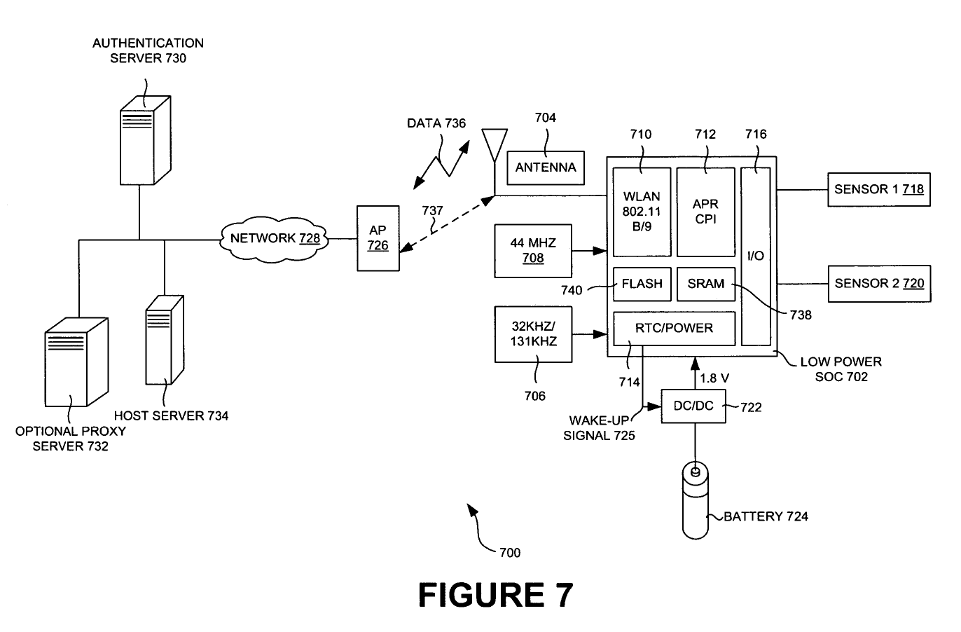

In another example embodiment, a heartbeat signal of a device (e.g., the wireless device 508 of FIG. 5) may be communicated to a control point (e.g., the control point 506 of FIG. 5) when the device is coupled to a network (e.g., the wireless network 500 of FIG. 5) of the device and the control point managing the device. Also, a key exchange between the device and the control point may be performed to authenticate the device (e.g., using an authentication server 730 of FIG. 7). Furthermore, the device may be configured based on parameter data of the control point when the key exchange is successful.

The heartbeat signal may be used to inform the control point of a wake-up mode (e.g., when applications and/or WLAN are operational) of the device such that the control point is able to communicate with the device. Also, the key exchange may be performed periodically to check a tampering of the device such that the device is removed from the network when the tampering of the device is detected. Moreover, a tiered access (e.g., remotely) to a user of the network may be provided based on login data of the user (e.g., after the user is authenticated).

FIG. 7 is a low power wireless SOC 700 interacting with a host server 734 through an access point 726, according to one embodiment. An antenna 702 may be used to receive and/or transmit data 736 to and/or from the access point 726 (e.g., the gateway 110 of FIG. 1). A 32 kHz/131 kHz low-power crystal oscillator 704 may be used to drive a real time counter (RTC) 714 and a 44 MHz oscillator 708 may be used to drive a WLAN 710 and application (APP) CPUs. A flash memory 740 and a SRAM 738 may be used for the firmware update and/or a key management in encryption/decryption cores.

The RTC 714 may be also used to provide global time and/or date to the low power wireless SOC 700 (e.g., which may have a dedicated power supply). In one example embodiment, the low power wireless SOC 700 may be connected to two sensor devices (e.g., a sensor 1 718 and a sensor 2 720) via an I/O interface 716. The low power wireless SOC 700 may be powered by a battery 724 via a DC/DC converter 722 which converts the battery voltage to 1.8 V required for the operation of the low power wireless SOC 700.

In FIG. 7, data communication may take place between the sensors and the AP 726 via the low power wireless SOC 700 (e.g., which is compliant with the IEEE 802.11). The AP 726 may be connected via a network 728 to an authentication server 730 (e.g., which may be used to provide authentication services to the host server 734), an optional proxy server 732, etc.

Furthermore, one or more external devices (e.g., the sensor 1 718, the sensor 2 720, etc.) may perform one or more functions based on a control signal processed in each of the one or more external devices. The low power wireless SOC 700 having the RTC 714 (e.g., which is communicatively coupled to the one or more external devices) may periodically generate the control signal during a non-operational stage (e.g., and/or during an operational stage) of the low power wireless SOC 700 to minimize a power consumption. In addition, the WLAN 710 may communicate with the access point (AP) 726 using a radio (e.g., conforming to 802.11 a/b/g standard) based on an alarm signal generated by the each of the one or more external devices.

In one example embodiment, the periodic heartbeat signal may be generated using a counter (e.g., the real time counter 714) of the system on chip (e.g., the low power wireless system on chip 700) embedded in a device (e.g., the sensor 1 718, the sensor 2 720, etc.). The heartbeat signal may be communicated to the control point (e.g., the control point 506 of FIG. 5) managing the device to trigger a communication between the device and the control point (e.g., which may reside in the host server 734). The system on chip may be awakened (e.g., using the real time counter 714 of the system on chip 700) to generate the heartbeat signal when the counter of the system on chip reaches a preset value.

In another example embodiment, the real time counter module (e.g., the real time counter 714 of FIG. 7) may be used to count clock pluses of the system on chip (e.g., the system on chip 700 of FIG. 7) embedded in the device (e.g., the sensor 1 718, the sensor 2 720, etc.). The heartbeat module coupled to the real time counter module may be used to generate the heartbeat signal (e.g., where the heartbeat signal is periodically and/or aperiodically communicated to the control point such that a presence of the device is confirmed by the control point based on the heartbeat signal) when a number of the clock pluses is equivalent to a preset value to trigger a communication between the device and the control point managing the device.

Signal data of the control point may be communicated subsequent to the heartbeat signal to control the device based on the heartbeat signal. Also, the system on chip may be placed back to a sleep mode when the heartbeat signal is communicated to the control point to minimize the power consumption of the system on chip.

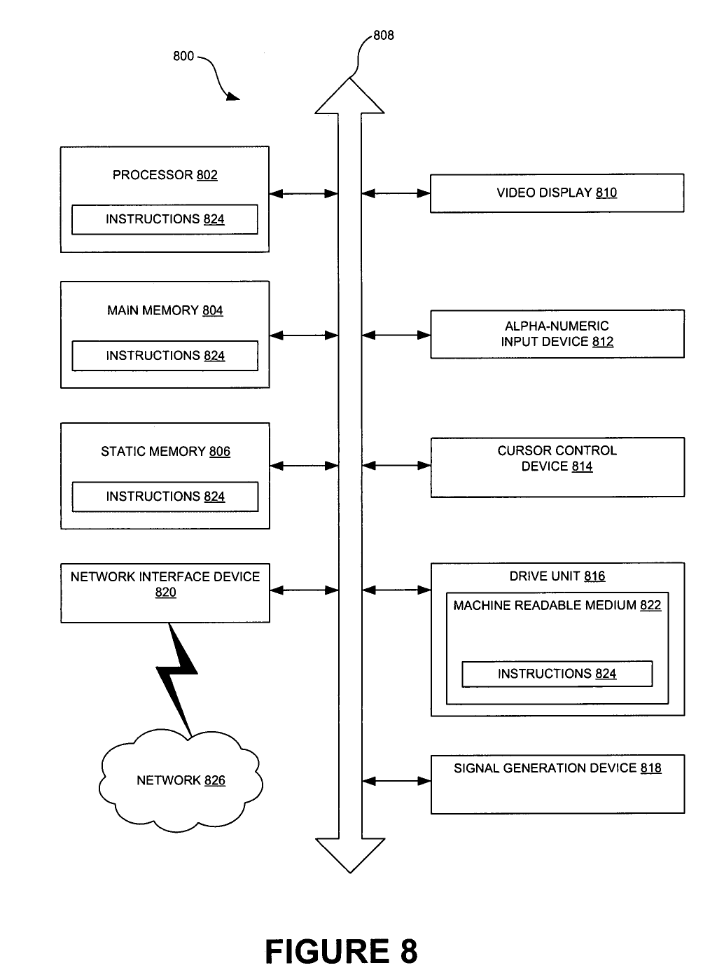

FIG. 8 is a diagrammatic representation of a computer system 800 capable of processing a set of instructions to perform any one or more of the methodologies herein, according to one embodiment. In various embodiments, the machine operates as a standalone device and/or may be connected (e.g., networked) to other machines. In a networked deployment, the machine may operate in the capacity of a server and/or a client machine in server-client network environment, and/or as a peer machine in a peer-to-peer (or distributed) network environment.

The machine may be a personal computer (PC), a tablet PC, a set-top box (STB), a Personal Digital Assistant (PDA), a cellular telephone, a web appliance, a network, a router, a switch and/or a bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 800 includes a processor 802 (e.g., a central processing unit (CPU) a graphics processing unit (GPU) and/or both), a main memory 804 and a static memory 806, which communicate with each other via a bus 808. The computer system 800 may further include a video display unit 810 (e.g., a Liquid Crystal Display (LCD) and/or a Cathode Ray Tube (CRT)). The computer system 800 also includes an alphanumeric input device 812 (e.g., a keyboard), a cursor control device 814 (e.g., a mouse), a disk drive unit 816, a signal generation device 818 (e.g., a speaker) and a network interface device 820.

The disk drive unit 816 includes a machine-readable medium 822 on which is stored one or more sets of instructions (e.g., software 824) embodying any one or more of the methodologies and/or functions described herein. The software 824 may also reside, completely and/or at least partially, within the main memory 804 and/or within the processor 802 during execution thereof by the computer system 800, the main memory 804 and the processor 802 also constituting machine-readable media.

The software 824 may further be transmitted and/or received over a network 826 via the network interface device 820. While the machine-readable medium 822 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

Although the present embodiments have been described with reference to specific example embodiments, it will be evident that various modifications and changes may be made to these embodiments without departing from the broader spirit and scope of the various embodiments. For example, the various devices, modules, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be enabled using transistors, logic gates, and electrical circuits (e.g., application specific integrated ASIC circuitry and/or in Digital Signal; Processor DSP circuitry).

Also, the method may be in a form of a machine-readable medium embodying a set of instructions that, when executed by a machine, cause the machine to perform any method disclosed herein. It will be appreciated that the various embodiments discussed herein may/may not be the same embodiment, and may be grouped into various other embodiments not explicitly disclosed herein.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method, comprising:
generating a periodic heartbeat signal using a counter of a system on chip embedded in a device; and
communicating the periodic heartbeat signal to a control point managing the device to trigger a communication between the device and the control point.

2. The method of claim 1, wherein the device is at least one of a wired device and a wireless device.

3. The method of claim 2, further comprising waking up the system on chip to generate the heartbeat signal when the counter of the system on chip reaches a preset value.

4. The method of claim 3, further comprising communicating signal data of the device to the control point, wherein the signal data to include at least a battery condition of the device.

5. The method of claim 4, further comprising configuring the device through processing configuration data of the control point.

6. The method of claim 5, further comprising performing a firmware update of the device through processing firmware update data of the control point.

7. The method of claim 6, further comprising initiating at least one operation of the device based on at least one command data of the control point.

8. The method of claim 7, further comprising varying a period of the periodic heartbeat signal based on a type of the device.

9. The method of claim 8, further comprising performing a two way communication between the device and the control point subsequent to the waking up the system on chip.

10. The method of claim 8, further comprising reverting the device to a sleep mode upon performing the communicating the heartbeat signal to the control point.

11. The method of claim 1, wherein the periodic heartbeat signal is converted to an aperiodic heartbeat signal through adding a random time to a period of the periodic heartbeat signal.

12. The method of claim 1 in a form of a machine-readable medium embodying a set of instructions that, when executed by a machine, causes the machine to perform the method of claim 1.

13. A method, comprising:
communicating a heartbeat signal of a device to a control point when the device is coupled to a network of the device and the control point managing the device;
performing a key exchange between the device and the control point to authenticate the device; and
configuring the device based on parameter data of the control point when the key exchange is successful.

14. The method of claim 13, wherein the heartbeat signal informs the control point a wake-up mode of the device such that the control point is able to communicate with the device.

15. The method of claim 14, wherein the performing the key exchange is performed periodically to check a tampering of the device such that the device is removed from the network when the tampering of the device is detected.

16. The method of claim 15, further comprising providing a tiered access to a user of the network based on login data of the user.

17. A system on chip, comprising:
a real time counter module to count clock pluses of the system on chip embedded in a device; and
a heartbeat module coupled to the real time counter module to generate a heartbeat signal when a number of the clock pluses is equivalent to a preset value to trigger a communication between the device and a control point managing the device.

18. The system on chip of claim 17, wherein the heartbeat signal is periodically communicated to the control point such that a presence of the device is confirmed by the control point based on the heartbeat signal.

19. The system on chip of claim 18, wherein signal data of the control point is communicated subsequent to the heartbeat signal to control the device.

20. The system on chip of claim 19, wherein the system on chip is placed back to a sleep mode when the heartbeat signal is communicated to the control point to minimize a power consumption of the system on chip.
